(19) United States
(12) Patent Application Publication
(10) Pub. No.: US 2017/0313128 A1
(43) Pub. Date: Nov. 2, 2017

(54) Tool for precision tightening of automotive wheel lug nuts

(71) Applicant: Joseph Brian Cleary, Hampton Bays, NY (US)

(72) Inventor: Joseph Brian Cleary, Hampton Bays, NY (US)

(21) Appl. No.: 15/143,861

(22) Filed: May 2, 2016

(51) Int. Cl. B60B 29/00

(52) U.S. Cl. CPC B60B 29/006

(57) ABSTRACT

This tool would make automotive wheel lug nut tightening an exact science, insuring precision from one job to the next. Chances for human error are minimized; once the tool is correctly applied to the lug nuts, there is no need to rely on any particular expertise from the mechanic, as the tool takes over setting the wheel properly, and then applying the final correct torque in accord with manufacturer's specification.

### CROSS REFERENCES TO RELATED APPLICATIONS

N/A

### STATEMENT REGARDING FEDERALLY SPONSORED RESEARCH OR DEVELOPMENT

N/A

### REFERENCE TO A “SEQUENCE LISTING”

N/A

### BACKGROUND OF THE INVENTION

Every day, in millions of automotive service facilities around the world, jobs are done that require the take-off & put-back of the wheels—jobs such as tire rotation, brakes, or even just an annual inspection. Any time an automotive wheel has to be put back, the way the lug nuts are tightened makes a difference; incorrect technique or incorrect torque application can result in damage to the brake rotors and/or wheel, resulting in a need for future repairs and even a potential safety concern (torque is the measure of tightness, in ft/lbs, applied to any fastener).

Two important points are part of proper wheel tightening; first, lug nuts should not be over-tightened initially, but just snugged-up with enough torque so the wheel sets evenly and straight on the hub, and is not subject to bending by one nut being excessively tightened compared to the others. Second, after the wheel has been set with minimal torque, and is resting even and straight on the hub, the lug nuts are again tightened—this time to the final torque level specified by the manufacturer.

At present the wheel put-back is done by hand, using a pneumatic driver. Torque wrenches and bars are available, which, if used properly, do help the mechanic tighten lug nuts to the manufacture's specification. However, the problem is as follows:

Most mechanics will tighten the lug nuts using a criss-cross pattern, eg., after tightening the nut at the one-o′clock axis, they would go to the nut at seven-o′clock—then to 5 o′clock—then to 11 o′clock, etc., until all are done. However, simply following this sequence, does not insure proper tightening, as there is nothing to protect the first nut from being over-tightened, causing the wheel to become pressed to the hub at that point; subsequent tightening of the other lug nuts, even if done in the criss-cross sequence, just bends the wheel further in the opposite direction, since the first over-tightened nut allows no give. Unequal application of torque to the lug nuts, even if it is the correct torque according to manufacturer's specifications, potentially bends both the wheel and brake rotors. Light weight specialty wheels, such as those made of aluminum, would be particularly susceptible.

An expert mechanic, exercising care, can minimize this problem. However, most shops emphasize getting jobs done quickly, and mechanics may be graded based on how rapidly they turn-over work. This can prompt a sacrifice of precision for speed, especially where the less-than-perfect result is not immediately apparent.

It would be useful, therefore, to have a tool that would make the put-back of a wheel easy, precise, and repeatable from one job to the next, from one mechanic to the next.

### BRIEF SUMMARY OF THE INVENTION

This tool would provide for 1) the simultaneous, initial tightening of lug nuts to a torque that is just enough to set the wheel straight and even on the hub (eg., 30 ft/lbs), and then, 2) the simultaneous, final tightening of the nuts to the manufacturer specified torque (eg., 100 ft/lbs).

### DETAILED DESCRIPTION OF THE INVENTION

While tool company engineers would ultimately determine the size and shape of the apparatus, general dimensions, as I see it, would be about the size of a laptop computer, but thicker in depth. The device would rest on a portable rolling dolly frame, positioned so the screen is waist-high to the average person. The front face of the device would have a digital read-out screen, which would display the torque values chosen by the operator from a set of push-buttons, also on the front of the device. Projecting from the back of the device would be five, flexible, goose neck-type lines, each about twenty-four (24) inches in length; these torque transmission lines would be placed on the lug nuts by an appropriate size socket.

A storage chest for the sockets (eg., ¾, ⅞), different length goose neck lines, and other items, would be part of the portable dolly frame. The best power source is probably pneumatic, but tool company engineers could use other sources, such as a re-chargeable battery incorporated into the portable dolly frame.

The device would be operated as follows: The mechanic begins as usual by placing the wheel on the hub, and, by hand, each lug nut on the threaded stems of the hub; from the device a goose neck line, with the appropriate size socket on-end, is placed on each lug nut; the mechanic then chooses an initial low torque, such as 30 ft/lbs, from the push button dial on the face of the device—the torque values chosen appear on the digital screen; power is switched on, and simultaneously all lug nuts are tightened to 30 ft/lbs, setting the wheel evenly on the hub in preparation for the final torque application; using the push button dial, the mechanic now chooses the proper final torque from manufacturer specifications—typically 100 ft/lbs; power is switched on again, and, simultaneously, all lug nuts are driven to the precise tightness, according to specs. The torque transmission lines are removed from each lug nut—and a precision put-back of the wheel has been completed.

1. This tool would provide for the simultaneous, power-driven, precision tightening of automotive wheel lug nuts, thus minimizing the chances for human error.
